(19) United States
(12) Patent Application Publication
(10) Pub. No.: US 2006/0125914 A1
(43) Pub. Date: Jun. 15, 2006

(54) Video input for conversation with sing language, video i/o device for conversation with sign language, and sign language interpretation system

(76) Inventor: Nozomu Sahashi, Osaka (JP)

Correspondence Address: KEATING & BENNETT, LLP, 8180 GREENSBORO DRIVE, SUITE 850, MCLEAN, VA, 22102, US

(21) Appl. No.: 10/528,086

(22) PCT Filed: Sep. 16, 2003
(86) PCT No.: PCT/JP03/11759

§ 371 Date: Nov. 17, 2005

(30) Foreign Application Priority Data
Sep. 17, 2002 (JP) 2002-269852

(51) Int. Cl. H04N 7/14

(52) U.S. Cl. 348/14.02; 379/93.19; 379/93.21

(57) ABSTRACT

A videophone sign language conversation assistance device includes a target imaging camera for imaging a target other than a sign language, a sign language imaging camera for imaging the sign language of a deaf-mute person, a waist fixing device for fixing the sign language imaging camera at the waist of the deaf-mute person, a video synthesizer for synthesizing the videos of the cameras, and a videophone connection device for supplying the synthesized video to a videophone terminal. The device further includes a display device for displaying the sign language and a fixing device for fixing the display device in front of the eyes of the deaf-mute person, such that the sign language video being received at the video telephone terminal is supplied to the display device. A sign language interpretation system provides a sign language interpretation service which can be used when a deaf-mute person converses with a non-deaf-mute person by using the above-described device.

### BACKGROUND OF THE INVENTION

1. Field of the Invention

The present invention relates to a videophone sign language conversation assistance device and a sign language interpretation system using the same which are used by deaf-mute persons to have a sign language conversation using a videophone, and in particular, the present invention relates to a videophone sign language conversation assistance device and a sign language interpretation system using the same which are used to transmit a video other than sign language while performing sign language.

2. Description of the Related Art

While sign language is important for communicating with a deaf-mute person, the picture quality of prior art videophones was poor and not sufficient for sign language conversations between deaf-mute persons in remote locations. With recent advancements in communications technology, the picture quality of a videophone has been greatly improved. Accordingly, sign language conversation between deaf-mute persons in remote locations is now practical and available.

FIG. 13 shows a conceptual diagram of a sign language conversation between deaf-mute persons using a prior art videophone. In FIG. 13, a numeral 10 represents a videophone terminal used by a deaf-mute person A and numeral 20 represents a videophone terminal used by a deaf-mute person B. The deaf-mute person A sets the videophone terminal 10 such that his/her sign language will be captured by an imaging section 10b and the sign language of the deaf-mute person B displayed in a video display section 10a will be viewed. Similarly, the deaf-mute person B sets the videophone terminal 20 such that his/her sign language will be captured by an imaging section 20b and the sign language of the deaf-mute person A displayed in a video display section 20a will be viewed. By doing so, the deaf-mute person A and the deaf-mute person B have a sign language conversation via a videophone. While a cellular phone is used as a videophone terminal in this example, a desktop-type videophone terminal may be also used.

Next, a situation will be described in which a deaf-mute person converses with a non-deaf-mute person by using a videophone terminal via a sign language interpreter. Such sign language interpretation is implemented by using, for example, a multipoint connection unit which interconnects three or more videophone terminals to provide teleconference services.

FIG. 14 is a conceptual diagram of a sign language interpretation service using a prior art multipoint connection unit. In FIG. 14, numeral 10 represents a videophone terminal for deaf-mute persons used by a deaf-mute person A (hereinafter referred to as a deaf-mute person terminal), numeral 20 represents a videophone terminal for non-deaf-mute persons used by a non-deaf-mute person B (hereinafter referred to as a non-deaf-mute person terminal), and numeral 30 represents a videophone terminal for sign language interpreters used by a sign language interpreter C (hereinafter referred to as a sign language interpreter terminal). Numeral 1 represents a multipoint connection unit.

The multipoint connection unit 1 accepts connections from the terminals 10, 20, 30, receives video and audio transmitted from the terminals, synthesizes the received video and audio, and delivers the resulting video and audio to each terminal. Thus, a video obtained by synthesizing the videos from the terminal is displayed on the display screens (10a, 20b, 30b) of the terminals. An audio obtained by synthesizing audios collected by the microphones of the headsets (20c, 30c) is output to loudspeakers such as the headsets (20c, 30c) of the terminals. Synthesis of videos uses, for example, a four-way synthesis which equally synthesizes the videos of all parties engaged. The deaf-mute person A does not use audio input/output such that the headset of the deaf-mute person terminal 10 is omitted and voice communications are provided only between the non-deaf-mute person and the sign language interpreter. Where the environmental or background sound is collected by the deaf-mute person terminal 10 and transmitted, or where a helper is present with the deaf-mute person, a microphone or a headset may be provided.

With this configuration, when the deaf-mute person A performs sign language, the sign language interpreter C watches the sign language of the deaf-mute person A and translates it into a voice. The non-deaf-mute person B listens to the voice of the sign language interpreter C to understand the sign language of the deaf-mute person A. When the non-deaf-mute person B speaks, the sign language interpreter C listens to the voice of the non-deaf-mute person B and translates it into sign language. The deaf-mute person A watches the sign language of the sign language interpreter C to understand the speech of the non-deaf-mute person B.

However, in a conversation between deaf-mute persons using a videophone or a conversation between a deaf-mute person and a non-deaf-mute person via sign language interpretation, the videophone terminal for deaf-mute persons must capture the sign language of the deaf-mute person and transmit the video to the distant party while the deaf-mute person is performing sign language, such that the videophone terminal for deaf-mute persons cannot transmit other videos to the distant party. Thus, the deaf-mute person cannot transmit a video other than sign language and explain the video using sign language in a videophone conversation.

In this manner, while it is possible to transmit a target video and explain the video using voice in a videophone conversation between unimpaired persons, it is not possible to transmit a target video and explain the target video in a videophone conversation involving a deaf-mute person. As a result, explanation of a target is imprecise and a quick conversation is difficult.

### SUMMARY OF THE INVENTION

To overcome the problems described above, preferred embodiments of the present invention provide a videophone sign language conversation assistance device, and a sign language interpretation system using same to enable a deaf-mute person to transmit a target video other than sign language while performing explanation by sign language.

According to a preferred embodiment of the present invention, a videophone sign language conversation assistance device used by a deaf-mute person to have a sing language conversation using a videophone includes hand imaging means including waist fixing means to be fixed at the waist of a deaf-mute person for capturing images of the hands of the deaf-mute person to acquire a sign language video, sight line direction imaging means fixed to the head of the deaf-mute person and arranged to capture images of the area in the direction of the sight line of the deaf-mute person, video signal synthesis means for synthesizing a video signal acquired by the hand imaging means and a video signal acquired by the sight line direction imaging means, and a videophone connection means including a function to transmit a video signal synthesized by the video signal synthesis means to a videophone terminal, wherein the deaf-mute person can include an explanation by sign language while transmitting a video in the sight line direction.

With this configuration, the deaf-mute person can precisely explain the target in the sight line direction, and thus, a conversation with sign language is sped up.

The videophone connection means can be connected to a videophone of the cellular phone. Thus, a deaf-mute person can transmit to the opponent party a video other than sign language with explanation by sign language added even while moving, which adds to the convenience to the deaf-mute person.

The sign language of the deaf-mute person is captured under certain conditions and transmitted to the opponent party even when the deaf-mute person changes his/her position or orientation. This allows a stable conversation with sign language.

The video signal synthesis means preferably includes a function to synthesize a video signal captured by the sight line direction imaging means as a main window and a video signal acquired by the hand imaging means as a sub window in a Picture-in-Picture arrangement and a function to change the setting of the position of the sub window

The videophone sign language conversation assistance device preferably includes display means fixed to the head of the deaf-mute person for displaying a video received by the videophone terminal in front of the eyes of the deaf-mute person and simultaneously allowing the deaf-mute person to view the outer world including a target for sign language conversation, and the videophone connection means preferably includes a function to receive a video signal from the videophone terminal and supply the video signal to the display means.

With this configuration, the deaf-mute person is able to include an explanation by sign language while transmitting a video other than sign language, as well as receive an explanation by sign language while viewing the outer world by freely shifting his/her sight line. The display means fixed in front of the deaf-mute person is preferably as small as possible so as not to obstruct viewing of the outer world.

The sight line direction imaging means and the display means are preferably molded into a frame which can be fixed to the ears and nose of said deaf-mute person.

This enables the deaf-mute person to readily set the sight line direction imaging means and the display means at the optimum position in front of his/her eyes.

The videophone connection means preferably includes radio communications means for performing radio communications with the videophone terminal.

This eliminates the need to connect the videophone sign language conversation assistance device to a videophone terminal via a cable, which greatly facilitates handling.

According to another preferred embodiment of the present invention, a videophone sign language interpretation system connects the videophone sign language conversation assistance device according to the preferred embodiment described above with the videophone terminal of a deaf-mute person, and interconnects the videophone terminal of the deaf-mute person, the videophone terminal of a non-deaf-mute person and the videophone terminal of a sign language interpreter in order to provide sign language interpretation by a sign language interpreter in a videophone conversation between a deaf-mute person and a non-deaf-mute person, wherein the videophone sign language interpretation system includes terminal connection means including a sign language interpreter registration table where the terminal number of the videophone terminal of a sign language interpreter is registered, the terminal connection means including a function to accept a call from the videophone terminal of the deaf-mute person or videophone terminal of the non-deaf-mute person, a function to prompt a calling videophone terminal for which the call is accepted to enter the terminal number of the called terminal, a function to extract the terminal number of the videophone terminal of a sign language interpreter from the sign language interpreter registration table, a function to call the videophone terminal of a sign language interpreter by using the extracted terminal number, and a function to call the called videophone terminal by using the acquired called terminal number, and video/audio communications means including a function to synthesize at least a video from the videophone terminal of the non-deaf-mute person and a video from the videophone terminal of the sign language interpreter and transmit the resulting video to the videophone terminal of the deaf-mute person, a function to transmit at least a video from the videophone terminal of the deaf-mute person and an audio from the videophone terminal of the sign language interpreter to the videophone terminal of the non-deaf-mute person and a function to transmit at least a video from the videophone terminal of the deaf-mute person and an audio from the videophone terminal of the non-deaf-mute person to the videophone terminal of the sign language interpreter.

In this manner, a function is provided to extract and call the terminal number of a sign language interpreter registered in a sign language interpreter registration table. A sign language interpreter can provide sign language interpretation anywhere he/she may be, as long as he/she has access to a videophone terminal. This provides a flexible and efficient sign language interpretation system.

Selection information for selecting a sign language interpreter is preferably registered in the sign language interpreter registration table, and the terminal connection means includes a function to acquire the conditions for selecting a sign language interpreter from the calling videophone terminal and a function to extract the terminal number of a sign language interpreter who satisfies the acquired selection conditions for the sign language interpreter from the sign language interpreter registration table.

With this configuration, a sign language interpreter who satisfies the object of the conversation between a deaf-mute person and a non-deaf-mute person from among the sign language interpreters registered in the sign language interpreter registration table is selected.

The sign language interpreter registration table preferably includes an availability flag to register whether a registered sign language interpreter is available, and the control means preferably refers to the availability flags in the sign language interpreter registration table to extract the terminal number of an available sign language interpreter. It is thus possible to automatically select an available sign language interpreter. This eliminates unnecessary calling and provides a more flexible and efficient sign language interpretation system.

The terminal connection means preferably includes a function to register a term in the term registration table via an operation from a videophone terminal, a function to select a term to be used from the terms registered in the term registration table via an operation from a videophone terminal, a function to generate a telop of the selected term, and a function to synthesize the generated telop onto a video to be transmitted to the opponent party.

This makes it possible to display, in a telop, on the videophone terminal of the conversation partner a term that is difficult to explain with sign language during sign language interpretation or a word that is difficult to pronounce.

The above and other features, elements, steps, characteristics and advantages of the present invention will be apparent from the following detailed description of preferred embodiments of the invention made referring to drawings.

### BRIEF DESCRIPTION OF THE DRAWINGS

FIG. 1 is a system block diagram of a videophone sign language conversation assistance device according to a preferred embodiment of the present invention;

FIG. 2 shows examples of a video displayed on the terminal of a party of a conversation with sign language via the video input/output device for sign language conversation according to a preferred embodiment of the present invention;

FIG. 3 is a system block diagram of a sign language interpretation system according to a preferred embodiment of the present invention;

FIG. 4 shows an example of a video displayed on each screen of a deaf-mute person terminal, non-deaf-mute person terminal, and sign language interpreter terminal in sign language interpretation using the sign language interpretation system according to a preferred embodiment of the present invention;

FIG. 5 is a process flowchart of a controller in a sign language interpretation system according to a preferred embodiment of the present invention;

FIG. 6 shows an example of a sign language interpreter registration table;

FIG. 7 shows an example of a screen for prompting input of a called terminal number;

FIG. 8 shows an example of a screen for prompting input of sign language interpreter selection conditions;

FIG. 9 shows an example of a screen for displaying a list of sign language interpreter candidates;

FIG. 10 is a system block diagram of a sign language interpretation system according to another preferred embodiment of the present invention;

FIG. 11 shows an example of a connection table;

FIG. 12 is a processing flowchart of the connection processing of a sign language interpretation system according to another preferred embodiment of the present invention;

FIG. 13 is a conceptual diagram showing a conversation with sign language between deaf-mute persons by using a prior art videophone terminal; and

FIG. 14 is a conceptual diagram of a sign language interpretation service using a prior art multipoint connection unit.

### DETAILED DESCRIPTION OF PREFERRED EMBODIMENTS

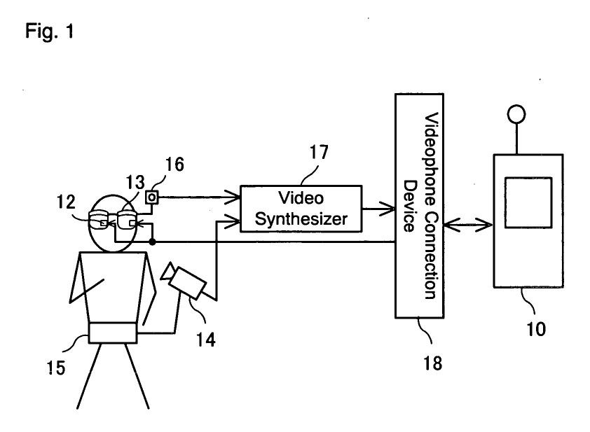

FIG. 1 is a system block diagram of a videophone sign language assistance device according to a preferred embodiment of the present invention. In FIG. 1, numeral 12 represents a display device for displaying a sign language video, numeral 13 represents a fixture for fixing the display device 12 in front of the eyes of a deaf-mute person, numeral 14 represents a sign language imaging camera for picking up the sign language of the deaf-mute person, numeral 15 represents a waist fixture for fixing the sign language imaging camera 14 at the waist of the deaf-mute person, numeral 16 represents a target imaging camera for picking up a target other than sign language, numeral 17 represents a video synthesizer for synthesizing a video from the sign language imaging camera 14 and a video from the target imaging camera 16, numeral 18 represents a videophone connection device for connecting the display device 12 and the video synthesizer 17 to a videophone terminal 10.

The display device 12 uses, for example, a small-sized liquid crystal display having a sufficient resolution to display a sign language video. The display device 12 magnifies a video such that a deaf-mute person can recognize the sign language displayed with the fixture 13 attached. A convex lens is attached on the surface of the display device 12, such that sign language displayed on the display device 12 is brought into substantial focus while the deaf-mute person is viewing the outer world, such as, the conversation partner and the scenery. This enables the deaf-mute person to easily recognize the sign language displayed on the display device 12 while viewing the outer world.

The fixture 13 includes a spectacle frame structure which can be fixed to the ears and nose of a deaf-mute person. Near the frame in front of the eyes of the deaf-mute person the display device 12 is attached for viewing of sign language without impairing the sight of the outer world. While the display device 12 is provided in a lower left location in front of the eyes of the deaf-mute person in this example, the display device 12 may be provided anywhere as long as it does not impair the sight of the outer world.

While the display devices 12 are provided on the same right and left locations of the fixture 13 such that the deaf-mute person can more clearly view the displayed sign language in this example, the display unit 12 may be provided on either side of the fixture 13 as long as the deaf-mute person can view the displayed sign language.

The fixture 13 is used to locate the display device 12 in front of the eyes of the deaf-mute person, such that the display device 12 may be fixed to a hollow frame. Or, a transparent plate may be provided in a frame and the display unit 12 may be adhered to the transparent plate. Where the deaf-mute person has myopia, hyperopia, astigmatism, or presbyopia, and thus, requires a corrective lens, a corrective lens may be provided in a frame and the display device 12 may be adhered to the corrective lens.

The sign language imaging camera 14, such as a small-sized CCD camera, is fixed to the waist fixture 15. The sign language imaging camera 14 is set to an angle of view that is wide enough to capture the image of the sign language of the deaf-mute person while being fixed to the waist fixture 15.

The waist fixture 15 is, for example, a belt to fix the imaging camera 14a at the waist of a deaf-mute person. Any waist fixture may be used which includes a buckle having an arm for fixing the sign language imaging camera 14 to enable the sign language imaging camera 14 to be set in an orientation such that the sign language of the deaf-mute person can be captured. This makes it possible to stably capture the sign language of the deaf-mute person by using the sign language imaging camera 14, even when the deaf-mute person changes his/her position or orientation.

The target imaging camera 16, such as a small-sized CCD camera, is fixed to the side of the fixture 13. When the deaf-mute person wears the fixture 13, the azimuth of imaging by the target imaging camera 16 is substantially the same as the direction of the sight line of the deaf-mute person. This precisely captures the target for conversation for transmission of the video obtained.

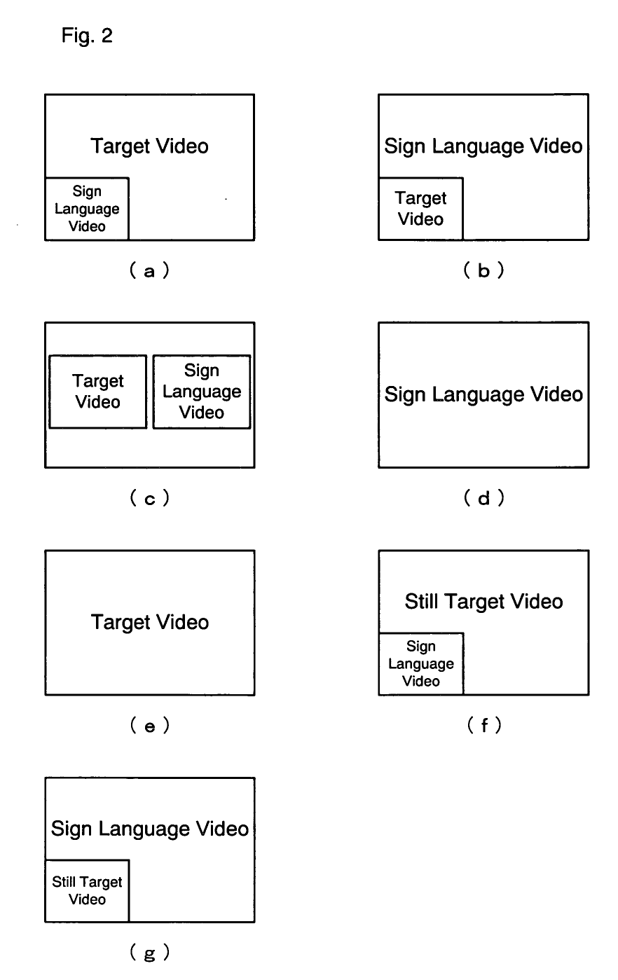

The video synthesizer 17 synthesizes a target video from the target imaging camera 16 and the sign language video from the sign language imaging camera 14 into a single synthesized video. Several methods for synthesis shown in FIG. 2 are available. A method may be selected therefrom depending on the purpose. FIG. 2(a) is a Picture-in-Picture representation where the target video is shown as a main window and the sign language video is shown as a sub window. On the other hand, FIG. 2(b) is a Picture-in-Picture representation where the sign language video is shown as a main window and the target video is shown as a sub window. FIG. 2(c) is a Picture-in-Picture representation where the target video and sign language videos are displayed in equal size. FIG. 2(d) shows the sign language video alone. FIG. 2(e) shows the target video alone. FIG. 2(f) is a Picture-in-Picture representation where a still picture of the target video is shown as a main window and the sign language video is shown as a sub window. On the other hand, FIG. 2(g) is a Picture-in-Picture representation where the sign language video is shown as a main window and a still picture of the target video is shown as a sub window.

The setting of the position of the sub window in a Picture-to-Picture representation is preferably subject to change as required so as not to obstruct the view of important information in a main window or hide another sub window inserted in sign language interpretation described later.

The video synthesizer 17 may be accommodated in the waist fixture 15 or fixture 13 so as to supply a video signal from the target imaging camera 16 or sign language imaging camera 14 to the video synthesizer 17 accommodated in the waist fixture 15 or fixture 13 over a wired or wireless connection.

The videophone connection device 18 is a device which connects the display device 12 and the video synthesizer 17 with the external device connecting terminal of the videophone terminal 10. The videophone connection device 18 supplies a video signal received by the videophone terminal 10 to the display device 12, and supplies a video signal from the video synthesizer 17 to the videophone terminal 10. Thus, the display device 12 is to be an external video display device of the videophone terminal 10 and the target imaging camera 16 and the sign language imaging camera 14 is to be an external imaging device of the videophone terminal 10.

When such a videophone sign language conversation assistance device is connected to a videophone terminal and a sign language conversation is initiated, the deaf-mute person can transmit a target video along with a sign language explanation of the target video to the conversation partner. This provides the same advantages as that obtained by an unimpaired person's aural explanation of the target video. As a result, a shorter conversation is achieved. Further, it is possible to transmit information about the target to the conversation partner in a more efficient and precise manner.

While the fixture 13 for fixing the display device 12 in front of the eyes of a deaf-mute person uses a spectacle frame structure in the above-described preferred embodiment, the fixture 13 may include a hair band fixed to the head equipped with an arm for supporting the display device 12, or any suitable structure as long as the display device 12 can be fixed in front of the eyes of the deaf-mute person.

While the target imaging camera 16 is fixed to the side of the fixture 13 in the above-described preferred embodiment, the present invention is not limited thereto. The target imaging camera 16 may be fixed to the head of the deaf-mute person separately from the fixture 13.

While the sign language imaging camera 14 includes the waist fixture 15 fixed at the waist of the deaf-mute person in the above-described preferred embodiment, the sign language imaging camera 14 may use any type of fixing device as long as it can capture the sign language of the deaf-mute person.

While the target imaging camera 16 for capturing a target for a conversation other than sign language is provided in the above-described preferred embodiment, an external video signal input terminal for inputting external video signal may be provided and a video signal input from the external video signal input terminal and a video signal from the sign language imaging camera 14 may be synthesized by the video synthesizer 17 for transmission to the conversation partner. With this configuration, it is possible to display a video from an external camera or a video from a VTR as a target for the conversation and discussion with the partner about the contents of the video via sign language.

While the videophone connection device 18 connects the display device 12 and the video synthesizer 17 with the external device connecting terminal of the videophone terminal 10, via wires in the above-described preferred embodiment, a radio communications device for wirelessly transmitting/receiving a video signal may be provided on each of the external device connecting terminal of the videophone terminal 10, the fixture 13 and the video synthesizer 17. This eliminates the need for cables to be connected to the videophone terminal 10, the fixture 13, and the video synthesizer 17, which facilitates handling of the device.

Where the videophone terminal 10 includes a wireless interface conforming to a standard such as Bluetooth® for communicating with an external device, a communications device conforming to the same standard should be provided on each of the fixture 13 and the video synthesizer 17. By doing so, it is possible to communicate a video signal without physically connecting anything to the videophone terminal 10 as long as the communications devices provided on the fixture 13 and the video synthesizer 17 are within the service area of the wireless interface of the videophone terminal 10, which further facilitates handling.

While a videophone terminal of a telephone type, especially a videophone terminal of a cellular phone type is used in the above-described preferred embodiment, the present invention is not limited thereto. A videophone terminal of the IP type to connect to the internet may also be used.

While the above-described preferred embodiment describes a videophone sign language conversation assistance device including a sign language imaging camera 14, a target imaging camera 16, a video synthesizer 17, a display device 12, a fixture 13, and a videophone connection device 18, wherein the videophone sign language conversation assistance device includes both a function to synthesize a sign language video and a target video and supplying the resulting video to the videophone terminal 10 and a function to acquire a sign language video being received by a videophone terminal 10 and display the sign language video on the display device 12, a video input device for sign language conversation including a sign language imaging camera 14 for picking up sign language, a target imaging camera 16 for picking up a target other than sign language, a video synthesizer 17 for synthesizing a video from the sign language imaging camera 14 and a video from the target imaging camera 16, and a videophone connection device 18 for supplying the synthesized video signal to the videophone terminal 10 allows the deaf-mute person to provide a sign language explanation while transmitting the video of a target other than sign language to the conversation partner.

Next, a sign language interpretation system will be described which enables selection of a sign language interpreter satisfying the object of a conversation when a deaf-mute person converses with a non-deaf-mute person via a sign language interpreter by using a videophone sign language converstation assistance device.

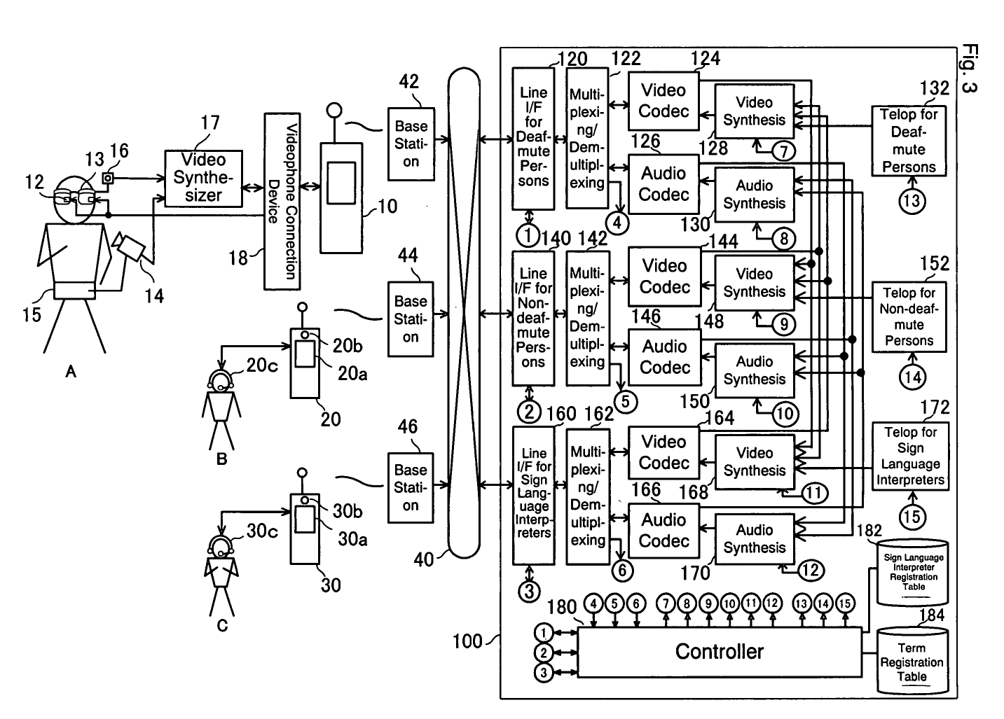

FIG. 3 is a system block diagram of a sign language interpretation system according to a preferred embodiment of the invention. In FIG. 3, numeral 100 represents a sign language interpretation system installed in a sign language interpretation center which provides a sign language interpretation service. The sign language interpretation system 100 interconnects, via a public telephone line 40, a videophone terminal for deaf-mute persons used by a deaf-mute person A (hereinafter referred to as a deaf-mute person terminal) 10, a videophone terminal for non-deaf-mute persons used by a non-deaf-mute person B (hereinafter referred to as a non-deaf-mute person terminal) 20, and a videophone terminal for sign language interpreters used by a sign language interpreter C (hereinafter referred to as a sign language interpreter terminal) 30 in order to provide a sign language interpretation service in a videophone conversation between a deaf-mute person and a non-deaf-mute person. In this preferred embodiment, each of the deaf-mute person terminal 10, non-deaf-mute person terminal 20 and sign language interpreter terminal 30 is preferably a telephone-type videophone terminal to be connected to a public telephone line, and in particular, a wireless videophone terminal of the cellular phone type.

Such a videophone terminal connected to a public line may be an ISDN videophone terminal based on ITU-T recommendation H.320, the present invention is not limited thereto and may use a videophone terminal which uses a unique protocol.

When the video input/output device for conversation with sign language is connected to the deaf-mute person terminal 10 and the deaf-mute person A wears the fixture 13 and the waist fixture 15, a sign language video received by the deaf-mute person terminal 10 is displayed on the display device 12 fixed in front of the eyes of the deaf-mute person A. The target imaging camera 16 for picking up the area in the direction of sight line of the deaf-mute person A and the sign language imaging camera 14 for picking up the sign language of the deaf-mute person are set and a synthesized video including a video of the target and explanation by sign language is transmitted to the other party.

The non-deaf-mute person terminal 20 is a general videophone terminal including a video display section 20a for displaying a video received from the other party, an imaging section 20b for picking up the user or target, and a headset 20c for audio input/output.

The sign language interpreter terminal 30 is also a general videophone terminal having a similar configuration to the non-deaf-mute person terminal 20, except that the video display section 30a is primarily used to view the sign language of the deaf-mute person A and the video imaging section 30b is primarily used to pick up the sign language translated into by the sign language interpreter. The headset 30c is primarily used to listen to the voice of the non-deaf-mute person B and to input the translation of the sign language of the deaf-mute person A.

While input/output of voice is made using a handset on a typical telephone-type terminal, a headset is used instead in order to keep both hands of the user who performs sign language free. In the following description, a terminal uses a headset fixed on the head of the user including a non-deaf-mute person B. While a headset is not shown on the deaf-mute person terminal 10, a headset may be used and voice communications may also be used in situations where a helper is present.

The sign language interpretation system 100 includes a line interface 120 that is connected to a deaf-mute person terminal (hereinafter referred to as an I/F), a line I/F 140 that is connected to a non-deaf-mute person terminal, and a line I/F 160 that is connected to a sign language interpreter terminal. A multiplexer/demultiplexer 122, 142, 162 for multiplexing/demultiplexing a video signal is connected to each of the line I/F 120, 140, 160, an audio signal or a data signal, a video CODEC (coder/decoder) 124, 144, 164 for compressing/expanding a video signal, and an audio CODEC 126, 146, 166 for compressing/expanding an audio signal. Each line I/F, each multiplexer/demultiplexer, and each video CODEC or each audio CODEC perform call control, streaming control compression/expansion of a video/audio signal in accordance with a protocol used by each terminal.

A video synthesizer 128 for synthesizing the video output of the video CODEC 144 for the non-deaf-mute person terminal, the video output of the video CODEC 164 for the sign language interpreter terminal and the output of the telop memory 132 for the deaf-mute person terminal is connected to the video input of the video CODEC 124 for the deaf-mute person terminal.

An audio synthesizer 130 for synthesizing the audio output of the audio CODEC 146 for the non-deaf-mute person terminal and the audio output of the audio CODEC 166 for the sign language interpreter terminal 166 is connected to the audio input of the audio CODEC 126 for the deaf-mute person terminal.

While audio input/output is not generally provided on a deaf-mute person terminal, a voice communications function is preferably provided in situations in which the environment sound of a deaf-mute person terminal is to be transmitted to a non-deaf-mute person terminal or where a helper assists the deaf-mute person.

A video synthesizer 148 for synthesizing the video output of the video CODEC 124 for the deaf-mute person terminal, the video output of the video CODEC 146 for the sign language interpreter terminal 164 and the output of the telop memory 152 for the non-deaf-mute person terminal is connected to the video input of the video CODEC for the non-deaf-mute person terminal.

An audio synthesizer 150 for synthesizing the audio output of the audio CODEC 126 for the deaf-mute person terminal and the audio output of the audio CODEC 166 for the sign language interpreter terminal is connected to the audio input of the audio CODEC 146 for the non-deaf-mute person terminal.

While video display of a sign language interpreter may be omitted on a non-deaf-mute person terminal, understanding of the voice interpreted by the sign language interpreter is facilitated by displaying the video of the sign language interpreter, such that a function is preferably provided to synthesize the video of a sign language interpreter.

A video synthesizer 168 for synthesizing the video output of the video CODEC 124 for the deaf-mute person terminal, the video output of the video CODEC 144 for the non-deaf-mute person terminal and the output of the telop memory 172 for the sign language interpreter terminal is connected to the video input of the video CODEC 164 for the sign language interpreter terminal.

An audio synthesizer 170 for synthesizing the audio output of the audio CODEC 126 for the deaf-mute person terminal and the audio output of the audio CODEC 146 for the non-deaf-mute person terminal is connected to the audio input of the audio CODEC 166 for the sign language interpreter terminal.

While video display of a non-deaf-mute person may be omitted on a sign language interpreter terminal, understanding of the voice in interpreting the voice of a non-deaf-mute person is facilitated by displaying the video of the non-deaf-mute person, such that a function is preferably provided to synthesize the video of a non-deaf-mute person.

The sign language interpretation system 100 is equipped with a sign language interpreter registration table 182, in which the terminal number of a terminal for sign language interpreters used by a sign language interpreter is registered and includes a controller 180 connected to each of the line I/Fs 120, 140, 160, multiplexers/demultiplexers 122, 144, 162, video synthesizers 128, 148, 168, audio synthesizers 130, 150, 170, and telop memories 132, 152, 172. The controller 180 connects a calling terminal, a sign language interpreter terminal and a called terminal via a function to accept a call from a terminal used by a deaf-mute person or a terminal used by a non-deaf-mute person, a function to prompt a calling terminal to enter the called terminal number, a function to extract the terminal number of a sign language interpreter from the sign language interpreter registration table 182, a function to call the extracted terminal number, and a function to call the terminal number of the called terminal, and also provides a function to switch between video/audio synthesis methods used by video/audio synthesizers and a function to generate a telop and transmit the telop to a telop memory.

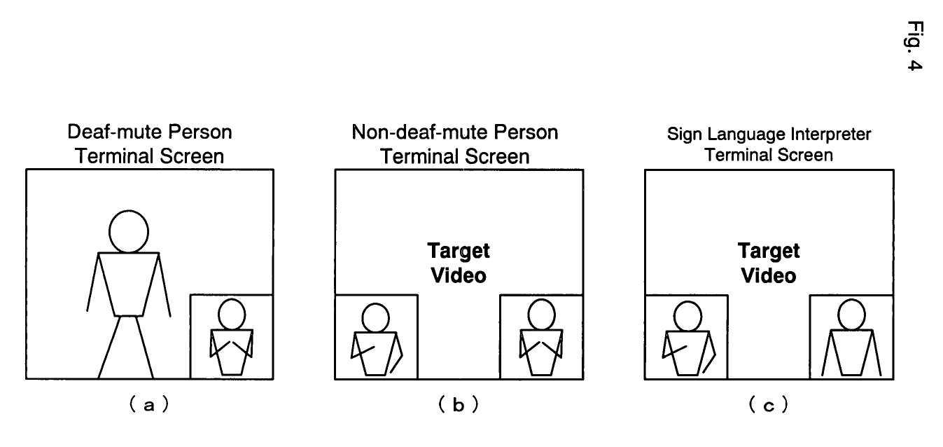

FIGS. 4(a)-4(c) show an example of a video displayed on the screen of each terminal during a videophone conversation via the sign language interpretation system according to a preferred embodiment of the present invention. FIG. 4(a) shows the screen of a deaf-mute person terminal. A video synthesizer 128 displays on the screen a video obtained by synthesizing a video of a non-deaf-mute person terminal and a video of a sign language interpreter terminal. While the video of the non-deaf-mute person is displayed as a main window and the video of the sign language interpreter is displayed as a sub window in a Picture-in-Picture fashion, a Picture-in-Picture display in which the video of the sign language interpreter as a the main window and the video of the non-deaf-mute person as a sub window is also possible. Alternatively, these videos may be displayed so as to have an equal size. When the video of a sign language interpreter is displayed in a larger size, the sign language interpreted by the sign language interpreter is easier to view and understand. A command from a terminal is preferably used to change the position of a sub window in the Picture-in-Picture display such that the sub window will not obstruct the view of important information in the main window.

FIG. 4(b) shows the screen of a non-deaf-mute person terminal. The video synthesizer 148 displays on the screen a video obtained by synthesizing a video of a deaf-mute person terminal and a video of a sign language interpreter terminal. While the video of the deaf-mute person terminal is a Picture-in-Picture representation including the target video captured by the target imaging camera 16, the sign language video captured by the sign language imaging camera 14 arranged on the lower left of the target video, and the video of the sign language interpreter arranged on the lower right of the target video. The video of the sign language interpreter may be omitted. By displaying the video of the sign language interpreter in a Picture-in-Picture fashion, the non-deaf-mute person can observe the expression of the sign language interpreter on the screen, which facilitates understanding of the voice translated into sign language by the sign language interpreter.

FIG. 4(c) shows the screen of a sign language interpreter terminal. The video synthesizer 168 displays on the screen a video obtained by synthesizing a video of a deaf-mute person terminal and a video of a non-deaf-mute person terminal. The video of the deaf-mute person terminal is a Picture-in-Picture representation including the target video captured by the target imaging camera 16, the sign language video captured by the sign language imaging camera 14 arranged on the lower left of the target video, and the video of the non-deaf-mute person arranged on the lower right of the target video. The video of the non-deaf-mute person may be omitted. By displaying the video of the non-deaf-mute person in a Picture-in-Picture fashion, the sign language interpreter can observe the expression of the non-deaf-mute person on the screen, which facilitates understanding of the voice of the non-deaf-mute person as a target for sign language interpretation.

To support a situation in which the environmental sound of a deaf-mute person terminal is to be transmitted or a situation in which a helper assists the deaf-mute person, a voice obtained by synthesizing the voice from the non-deaf-mute person terminal and the voice from the sign language interpreter terminal by using the audio synthesizer 130 is output to the deaf-mute person terminal, a voice obtained by synthesizing the voice from the deaf-mute person terminal and the voice from the sign language interpreter terminal by using the audio synthesizer 150 is output to the non-deaf-mute person terminal, and a voice obtained by synthesizing the voice from the non-deaf-mute person terminal and the voice from the deaf-mute person terminal by using the audio synthesizer 170 is output to the sign language interpreter terminal.

When it is not necessary to transmit the environmental sound of the deaf-mute person terminal or a helper is not present, the audio synthesizers 130, 150 and 170 may be omitted and the output of the audio CODEC 146 for the non-deaf-mute person terminal may be connected to the input of the audio CODEC 166 for the sign language interpreter terminal and the output of the audio CODEC 166 for the sign language interpreter terminal may be connected to the input of the audio CODEC 146 for the non-deaf-mute person terminal.

Operation of the video synthesizers 128, 148, 168 and audio synthesizers 130, 150, 170 is controlled by the controller 180. The user may change the video output method or audio output method by pressing a predetermined number button on a dial pad of each terminal. This is initiated when a push on the number button on the dial pad of each terminal is detected as a data signal or a tone signal by the multiplexer/demultiplexer 122, 144, 162 and detection of the push on the button is signaled to the controller.

With this configuration, flexibility in the usage of the system on each terminal is ensured. For example, only necessary videos or audios are selected and displayed/output in accordance with the object or it is possible to replace a main window with a sub window, or change the position of the sub window.

A telop memory 132 for the deaf-mute person, a telop memory 152 for the non-deaf-mute person, and a telop memory 172 for the sign language interpreter are respectively connected to the input of the audio synthesizers 128, 148, 168. Contents of each telop memory 132, 152, 172 are set by the controller 180.

With this configuration, by setting a message to be displayed on each terminal to the telop memories 132, 152, 172 and issuing an instruction to select a signal of the telop memories 132, 152, 172 to the audio synthesizers 128, 148, 168 in the setup of a videophone conversation via sign language interpretation, it is possible to transmit necessary messages to respective terminals to establish a three-way call.

In situations in which there is a term which is difficult to explain using sign language or a term which is difficult to pronounce in a videophone conversation, these terms may be registered in the term registration table 184 of the controller 180 corresponding to a number on the dial pad on each terminal. By doing so, it is possible to detect a push on the dial pad on each terminal during a videophone conversation, extract the term corresponding to the number of the dial pad pressed from the term registration table, generate a text telop, and set the text telop to each telop memory, thereby displaying the term on each terminal.

With this configuration, a term which is difficult to explain using sign language or a term which is difficult to pronounce is transmitted via a text telop to the conversation partner, thus, providing a quicker and more to-the-point videophone conversation.

Next, a processing flow of the controller 180 for setting a videophone conversation via sign language interpretation is explained.

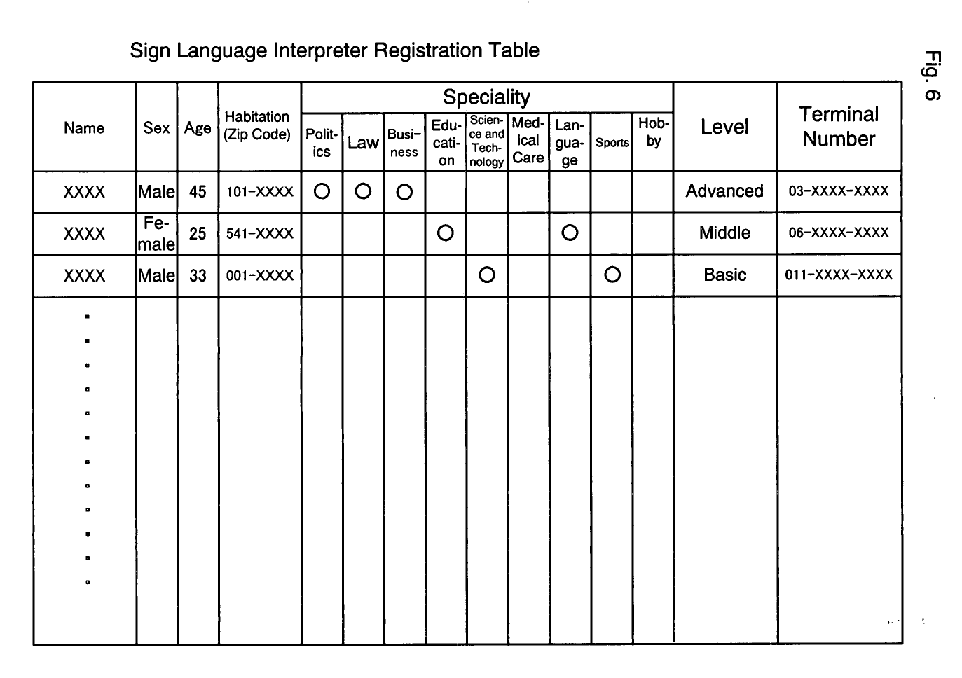

Prior to processing, information to select a sign language interpreter and the terminal number of a terminal used by each sign language interpreter are registered in the sign language interpreter registration table 182 of the controller 180 from an appropriate terminal (not shown). FIG. 6 shows an example of a registration item to be registered in the sign language interpreter registration table 182. The information to select a sign language interpreter refers to information used by the user to select a desired sign language interpreter, which includes sex, age, habitation, specialty, and level of sign language interpretation skill. Habitation assumes a situation in which the user wants a person who has geographic knowledge of a specific area and, in this example, a ZIP code is used to specify an area. Specialty assumes a situation in which the user wants a person who has expert knowledge in a particular field or is familiar with the topics in that field. In this example, the fields in which a sign language interpreter is familiar with are classified into several categories to be registered, such as politics, law, business, education, science and technology, medical care, language, sports, and hobby. The specialties are diverse, such that they may be registered hierarchically and searched at a level desired by the user when selected.

In addition, qualifications of each sign language interpreter may be registered in advance for the user to select a qualified person as a sign language interpreter.

The terminal number to be registered is the telephone number of the terminal, because in this example a videophone terminal to connect to a public telephone line is provided.

In the sign language interpreter registration table 182, an availability flag is provided to indicate whether sign language interpretation can be accepted. A registered sign language interpreter can call the sign language interpretation center from his/her terminal and enter a command by using a dial pad to set/reset the availability flag. Thus, a sign language interpreter registered in the sign language interpreter registration table can set the availability flag only when he/she is available for sign language interpretation, thereby eliminating useless calling and permitting the user to select an available sign language interpreter without delay.

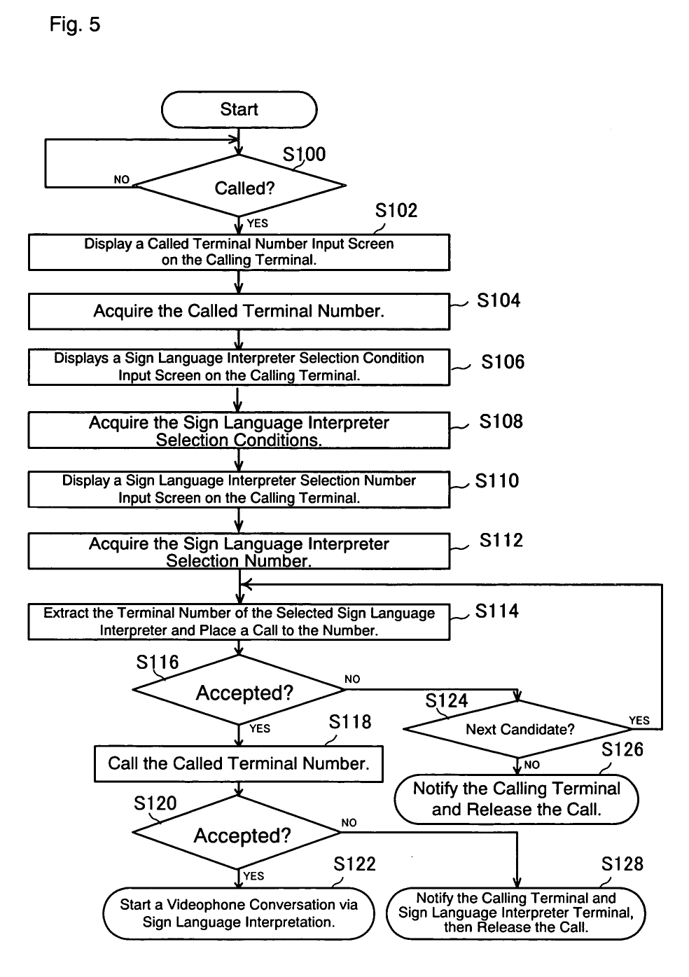

FIG. 5 shows a process flowchart of the controller 180. The sign language interpretation system 100 allows a deaf-mute person terminal or non-deaf-mute person terminal to propose a sign language interpretation service. From the deaf-mute person terminal, the user places a call to a telephone number on the line I/F for the deaf-mute person terminal. From the non-deaf-mute person terminal, the user places a call to a telephone number on the line I/F for the non-deaf-mute person terminal. This calls the sign language interpreter terminal and the partner's terminal and establishes a videophone connection via sign language interpretation.

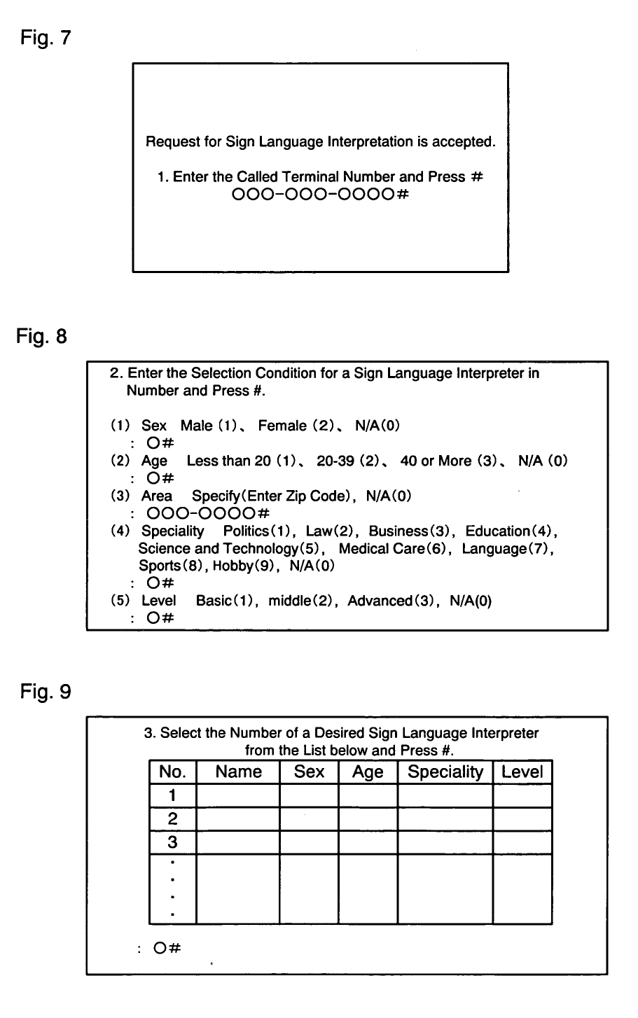

As shown in FIG. 5, the line I/F 120 for the deaf-mute person terminal or line I/F 140 for the non-deaf-mute person terminal that is called is detected first (S100). Next, the calling terminal displays a screen to prompt input of the terminal number of the called party shown in FIG. 7 (S102). The terminal number of the called party input by the caller is acquired (S104). The calling terminal displays a screen to prompt input of the selection conditions for a sign language interpreter shown in FIG. 8 (S106). The sign language interpreter selection conditions input by the caller are acquired (S108). The sign language interpreter selection conditions input by the caller are sex, age bracket, area, specialty and sign language level. A corresponding sign language interpreter is selected based on the sex, age, habitation, specialty, and sign language level registered in the sign language interpreter registration table 182. The area is specified by using a ZIP code and a sign language interpreter is selected starting with the habitation closest to the specified area. For any selections, if it is not necessary to specify a condition, N/A may be selected.

Next, a sign language interpreter with availability flag set is selected from among the sign language interpreters satisfying the selection conditions acquired referring to the sign language interpreter registration table 182. The calling terminal displays a list of sign language interpreter candidates shown in FIG. 9 to prompt input of the selection number of a desired sign language interpreter (S110). The selection number of the sign language interpreter input by the caller is acquired (S112) and the terminal number of the selected sign language interpreter is extracted from the sign language interpreter registration table 182 and the terminal is called (S114). When the sign language interpreter terminal has accepted the call (S116), the called terminal number is extracted and called (S118). When the called terminal has accepted the call (S120), a videophone conversation via sign language interpretation starts (S122).

When the sign language interpreter terminal selected in S166 does not accept the call, whether a next candidate is available is determined (S124). When a next candidate is available, execution returns to S114 and the procedure is repeated. Otherwise the calling terminal is notified as such and the call is released (S126).

When the called terminal does not accept the call in S120, the calling terminal and the selected sign language interpreter terminal are notified as such and the call is released (S128).

While when the selected sign language interpreter terminal does not accept the call, the caller is notified and the call is released in the above-described preferred embodiment, a sign language interpretation reservation table to register a calling terminal number and a called terminal number may be provided and the caller and the called party may be notified on a later response from the selected sign language interpreter to set a videophone conversation.

While the sign language interpretation system 100 includes a line I/F, a multiplexer/demultiplexer, a video CODEC, an audio CODEC, a video synthesizer, an audio synthesizer and a controller in the above-described preferred embodiment, these components need not be provided by individual hardware (H/W), but rather, the function of each component may be implemented by software running on a computer.

While the sign language interpreter terminal 30, is located outside the sign language interpretation center and called from the sign language interpretation center over a public telephone line to provide a sign language interpretation service in the above-preferred embodiment, the present invention is not limited thereto, and a portion or all of the sign language interpreters may be provided in the sign language interpretation center to provide a sign language interpretation service from the sign language interpretation center.

In the above-described preferred embodiment, a sign language interpreter may join a sign language interpretation service anywhere he/she maybe, as long as he/she has a terminal which can be connected to a public telephone line. Thus, the sign language interpreter can provide a sign language interpretation service by using the availability flag to make efficient use of free time. By doing so, it is possible to stably operate a sign language interpretation service accompanied by a problem of difficult reservation of a sign language interpreter. In particular, the number of volunteer sign language interpreters is increasing nowadays. A volunteer who is available only irregularly can provide a sign language interpretation service by taking advantage of their limited free time.

While a video signal of the home terminal is not input to the video synthesizers 128, 148, 168 in the above-described preferred embodiment, a function may be provided to input the video signal of the home terminal for later synthesis and display to check the video on the terminal.

While the video synthesizers 128, 148, 168 and the audio synthesizers 130, 150 170 are used to synthesize videos and audios for each terminal in the above-described preferred embodiment, the present invention is not limited thereto. Video and audio from all terminals may be synthesized at the same time and the resulting video or audio may be transmitted to each terminal.

While a function is provided such that the telop memories 132, 152, 172 are provided and telops are added to the video synthesizers 128, 148, 168 in order to display a text telop on each terminal in the above-described preferred embodiment, a function may be provided whereby a telop memory to store audio information and telops are added to the audio synthesizers 130, 150, 170 in order to output an audio message on each terminal. This makes it possible to set a videophone conversation via sign language interpretation even in case the non-deaf-mute person is a visually impaired person.

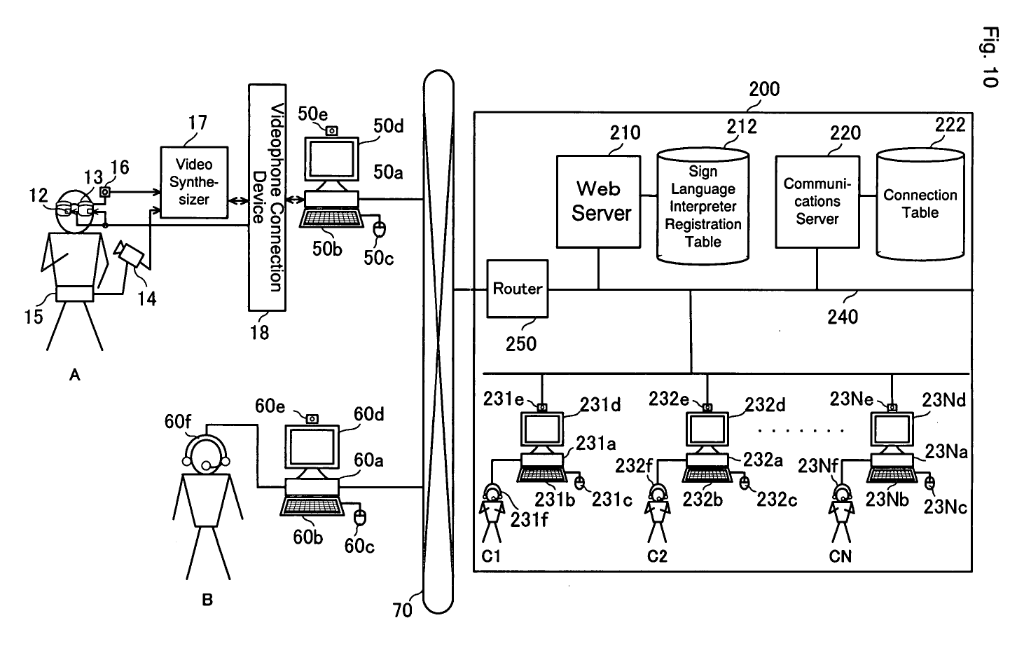

FIG. 10 is a system block diagram of a sign language interpretation system according to another preferred embodiment of the present invention. This preferred embodiment shows a system configuration example which assumes that each terminal used by a deaf-mute person, a non-deaf-mute person and a sign language interpreter is an IP (Internet Protocol) type videophone terminal to connect to the internet equipped with a web browser.

In FIG. 10, a numeral 200 represents a sign language interpretation system installed in a sign language interpretation center to provide a sign language interpretation service. The sign language interpretation system 200 connects a deaf-mute person terminal 50 used by a deaf-mute person, a non-deaf-mute person terminal 60 used by a non-deaf-mute person, and the selected sign language interpreter terminals used by a sign language interpreter 231, 232, . . . via the Internet 70, in order to provide a videophone conversation service via sign language interpretation between the deaf-mute person and the non-deaf-mute person.

While each of the deaf-mute person terminal 50, the non-deaf-mute person terminal 60 and the sign language interpreter terminals 231, 232, . . . includes a general-purpose processing device (a) such as a personal computer having a video input I/F function, an audio input/output I/F function and a network connection function, a keyboard (b) and a mouse (c) for input of information as well as a display (d) for displaying a web page screen presented by a web server 210 and a videophone screen supplied by a communications server 220, a television camera (e) for imaging the sign language of a sign language interpreter, and a headset (f) for performing audio input/output for the sign language interpreter, the processing device includes IP videophone software and a web browser installed in this example, a dedicated videophone terminal may be used instead.

The videophone terminal connected to the internet may be an IP videophone terminal based on ITU-T recommendation H.323, the present invention is not limited thereto, and may use a videophone terminal which operates according to a unique protocol.

The internet may be a wireless LAN. The videophone terminal may be a cellular phone or a portable terminal equipped with a videophone function and also including a web access function.

The sign language interpretation system 200 includes a communications server 220 including a connection table 222 for setting the terminal addresses of a deaf-mute person terminal, a non-deaf-mute person terminal and a sign language interpreter terminal as well as a function to interconnect the terminals registered in the connection table 222 and synthesize a video and an audio received from each terminal and transmit the synthesized video and audio to each terminal, a web server 210 including a sign language interpreter registration table 212 for registering the selection information, terminal address and availability flag of a sign language interpreter as mentioned earlier, as well as a function to select a desired sign language interpreter based on an access from a calling terminal by using a web browser and set the terminal address of each of the calling terminal, called terminal and sign language interpreter terminal in the connection table 222 of the communications server 220, a router 250 for connecting the web server 210 and the communications server 220 to the internet, and a plurality of sign language interpreter terminals 231, 232, . . . , 23N connected to the communications server 220 via a network.

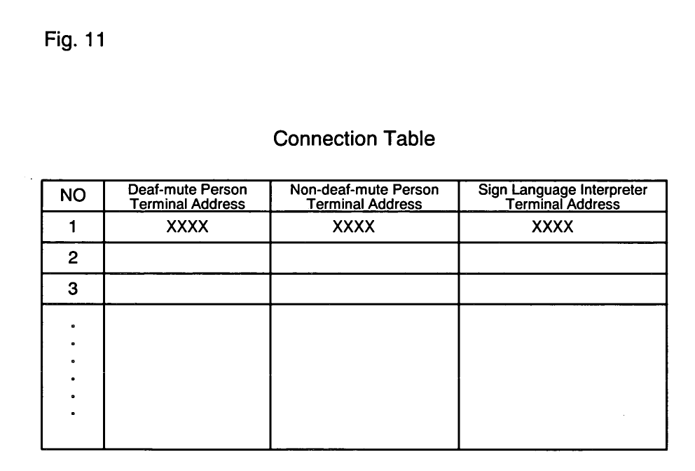

FIG. 11 shows an example of a connection table 222. As shown in FIG. 11, the terminal address of a deaf-mute person terminal, the terminal address of a non-deaf-mute person terminal and the terminal address of a sign language interpreter terminal are registered as a set in the connection table 222. This provides a single sign language interpretation service. The connection table 222 is designed to register a plurality of such terminal address set depending on the throughput of the communications server 220, thereby simultaneously providing a plurality of sign language interpretation services.

While the terminal address registered in the connection table 222 is an address on the internet and is generally an IP address, the present invention is not limited thereto, and, for example, a name given by a directory server may be used.

The communications server 220 performs packet communications using a predetermined protocol with the deaf-mute person terminal, non-deaf-mute person terminal and sign language interpreter terminal set to the connection table 222 and provides, by software processing, the functions similar to those provided by a multiplexer/demultiplexer 122, 142, 162, a video CODEC 124, 144, 164, an audio CODEC 126, 146, 166, a video synthesizer 128, 148, 168, an audio synthesizer 130, 150, 170 in the above-described sign language interpretation system 100.

With this configuration, similar to the sign language interpretation system 100, prescribed videos and audios are communicated between a deaf-mute person terminal, a non-deaf-mute person terminal and a sign language interpreter terminal, and a videophone conversation via sign language interpretation is established between the deaf-mute person and the non-deaf-mute person.

While the sign language interpretation system 100 uses the controller 180 and the telop memories 132, 152, 172 to extract a term registered in the term registration table 184 during a videophone conversation based on an instruction from a terminal and displays the term as a telop on the terminal, the same function may also be provided via software processing by the communications server 220 in this preferred embodiment. A term specified by each terminal may be displayed as a popup message on the other terminal by way of the web server 210. Or, a telop memory may be provided in the communications server 220 such that a term specified by each terminal will be written into the telop memory via the web server 210 and displayed as a text telop on each terminal.

While the sign language interpretation system 100 uses the controller 180 to interconnect a deaf-mute person terminal, a non-deaf-mute person terminal and a sign language interpreter terminal, the connection procedure is made by the web server 210 in this preferred embodiment because each terminal has a web access function.

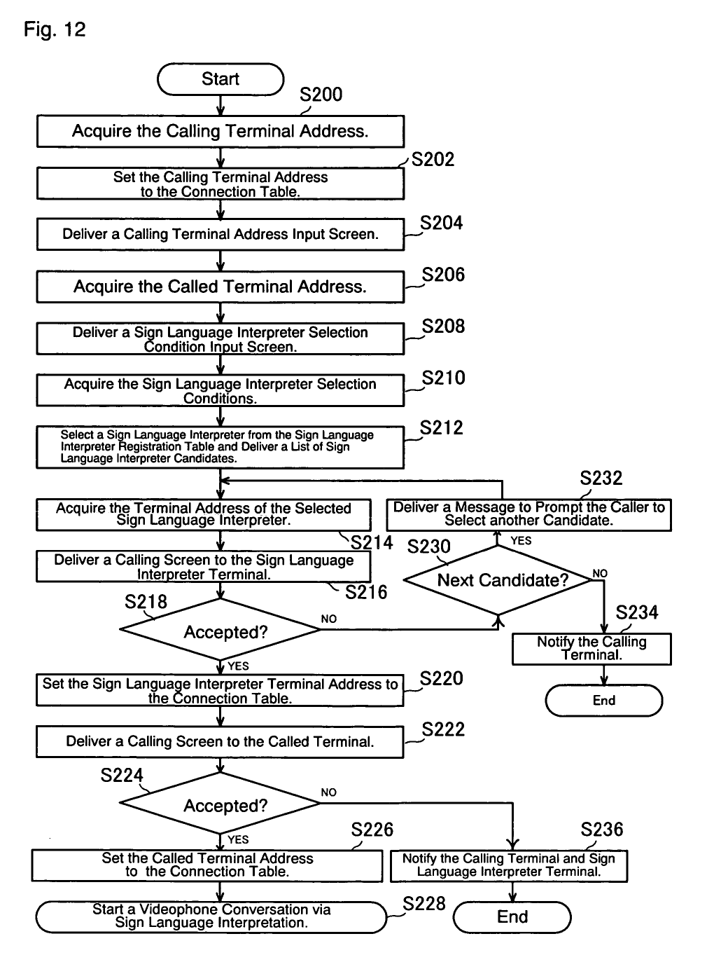

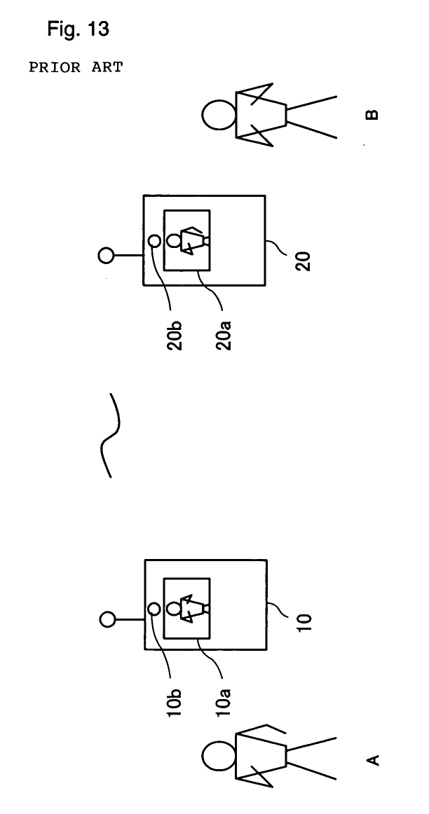

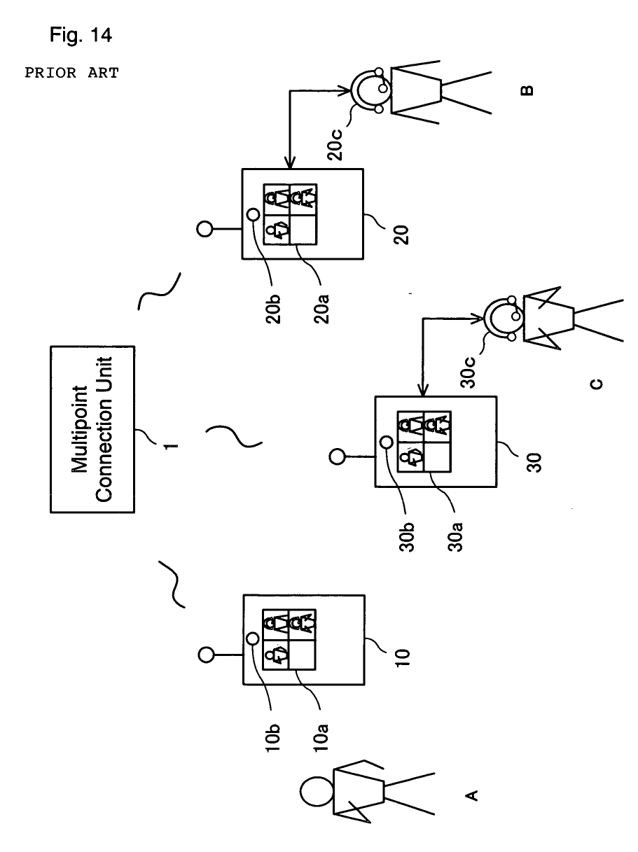

FIG. 12 is a processing flowchart of a connection procedure by the web server 210. The sign language interpretation system 200 also enables a deaf-mute person terminal or non-deaf-mute person terminal to request a sign language interpretation service. A deaf-mute person or a non-deaf-mute person wishing to request a sign language interpretation service accesses the web server 210 in the sign language interpretation center using a web browser to log in from each own terminal, which starts the acceptance of the sign language interpretation service.

As shown in FIG. 12, the web server 210 first acquires the terminal address of a caller (S200) and sets the terminal address to the connection table 222 (S202). Next, the web server delivers a screen to prompt input of the called terminal address similar to that shown in FIG. 7 to the calling terminal (S204). The called terminal address input by the caller is acquired (S206). The web server delivers a screen to prompt input of the selection conditions for a sign language interpreter similar to that shown in FIG. 8 to the calling terminal (S208). The sign language interpreter selection conditions input by the caller are acquired (S210).

Next, a sign language interpreter with an availability flag set is selected from among the sign language interpreters satisfying the selection conditions acquired from the sign language interpreter registration table 212. The web server 210 delivers a list of sign language interpreter candidates similar to that shown in FIG. 9 to the calling terminal to prompt input of the selection number of a desired sign language interpreter (S212). The selection number of the sign language interpreter input by the caller is acquired and the terminal address of the selected sign language interpreter is acquired from the sign language interpreter registration table 212 (S214). Based on the acquired terminal address of the sign language interpreter, the web server 210 delivers a calling screen to the sign language interpreter terminal (S216). If the call is accepted by the sign language interpreter (S218), the terminal address of the sign language interpreter is set to the connection table 222 (S220). Next, the web server 210 delvers a calling screen to the called terminal based on the acquired called terminal address (S222). If the call is accepted by the called terminal (S224), the called terminal address is set to the connection table 222 (S226). Then, a videophone conversation via sign language interpretation begins (S228).

If the sign language interpreter terminal does not accept the call in S218, whether a next candidate is available is determined (S230). If a next candidate is available, the web server delivers a message to prompt the caller to select another candidate (S232) to the calling terminal, and the execution returns to S214. If another candidate is not found, the calling terminal is notified (S234) and the call is released.

If the called terminal does not accept the call in S224, the calling terminal and the selected sign language interpreter terminal are notified (S236) and the call is released.

When the selected sign language interpreter terminal does not accept the call, the caller is notified and the call is released in the above-described preferred embodiments, a sign language interpretation reservation table to register a calling terminal address and a called terminal address may be provided and the caller and the called party may be notified of a later response from the selected sign language interpreter to set a videophone conversation.

While the sign language interpreter terminal is located in the sign language interpretation system 200 of the sign language interpretation center in the above-described preferred embodiments, the present invention is not limited thereto, and some or all of the sign language interpreter terminals may be provided outside the sign language interpretation center and connected via the Internet.

In the above-described preferred embodiments, the configuration of the sign language interpretation system has been described for a situation in which a videophone terminal used by a deaf-mute person, a non-deaf-mute person or a sign language interpreter is a telephone-type videophone terminal connected to a public telephone line, and a situation in which the videophone terminal is an IP-type videophone terminal connected to the Internet, the telephone-type videophone terminal and the IP-type videophone terminal can communicate with each other by arranging a gateway to perform protocol conversion therebetween. A sign language interpretation system conforming to one protocol may be provided via the gateway to support a videophone terminal conforming to the other protocol.

In this manner, the sign language interpretation system enables the user to enjoy or provide a sign language interpretation service anywhere he/she may be, as long as he/she has a terminal which can be connected to a public telephone line or the internet. A sign language interpreter does not always have to visit a sign language interpretation center but can present a sign language interpretation from his/her home or a facility or site where a videophone terminal is located, or provide a sign language interpretation service by using a cellular phone or a portable terminal equipped with a videophone function.

A person with the ability of sign language interpretation may wish to register in the sign language interpreter registration table in the sign language interpretation center in order to provide a sign language interpretation service whenever it is convenient to him/her. From the viewpoint of the operation of the sign language interpretation center, it is not necessary to summon sign language interpreters to the center. This provides efficient operation of the sign language interpretation center both in terms of time and costs. In particular, the number of volunteer sign language interpreters is increasing nowadays. The sign language interpretation service can be provided from a sign language interpreter's home, which facilitates reservation of a sign language interpreter.

As mentioned above, according to preferred embodiments of the present invention, a deaf-mute person can include an explanation with sign language while transmitting a target video other than sign language. It is thus possible to precisely explain the target to thereby speed up a conversation.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

1-10. (canceled)

11. A videophone sign language conversation assistance device used by a deaf-mute person to have a sign language conversation using of a videophone comprising:
hand imaging means including waist fixing means to be fixed at the waist of a deaf-mute person to capture images of the hands of said deaf-mute person to acquire a sign language video;
sight line direction imaging means fixed to the head of said deaf-mute person and arranged to capture images of an area in a direction of the sight line of said deaf-mute person;
video signal synthesis means for synthesizing a video signal captured by said hand imaging means and a video signal captured by said sight line direction imaging means; and
a videophone connection means for transmitting a video signal obtained through synthesis by said video signal synthesis means to a videophone terminal; wherein
the deaf-mute person can include an explanation by sign language while transmitting a video in the sight line direction.

12. The videophone sign language conversation assistance device according to claim 11, wherein said video signal synthesis means includes a function to synthesize a video signal captured by said sight line direction imaging means as a main window and a video signal captured by said hand imaging means as a sub window in a Picture-in-Picture arrangement and a function to change the setting of the position of said sub window.

13. The videophone sign language conversation assistance device according to claim 11, wherein said videophone sign language conversation assistance device includes display means fixed to the head of said deaf-mute person for displaying a video received by said videophone terminal in front of the eyes of said deaf-mute person and simultaneously enabling the deaf-mute person to view the outer world including a target for sign language conversation; and
said videophone connection means includes a function to receive a video signal from said videophone terminal and supply the video signal to said display means.

14. The videophone sign language conversation assistance device according to claim 13, wherein said sight line direction imaging means and said display means are molded into a frame which can be fixed to the ears and nose of said deaf-mute person.

15. The videophone sign language conversation assistance device according to claim 11, wherein said videophone connection means includes radio communications means for performing radio communications with said videophone terminal.

16. A videophone sign language interpretation system connecting the videophone sign language conversation assistance device according to claim 1 with the videophone terminal of a deaf-mute person and interconnecting the videophone terminal of said deaf-mute person, the videophone terminal of a non-deaf-mute person and the videophone terminal of a sign language interpreter in order to provide sign language interpretation by a sign language interpreter in a videophone conversation between a deaf-mute person and a non-deaf-mute person, wherein
said videophone sign language interpretation system includes terminal connection means including a sign language interpreter registration table where the terminal number of the videophone terminal of a sign language interpreter is registered;
said terminal connection means including a function to accept a call from said videophone terminal of said deaf-mute person or videophone terminal of said non-deaf-mute person, a function to prompt a calling videophone terminal for which said call is accepted to enter the terminal number of the called terminal, a function to extract the terminal number of the videophone terminal of a sign language interpreter from said sign language interpreter registration table, a function to call the videophone terminal of a sign language interpreter by using said extracted terminal number, and a function to call the called videophone terminal by using said acquired called terminal number; and
video/audio communications means including a function to synthesize at least a video from the videophone terminal of said non-deaf-mute person and a video from the videophone terminal of said sign language interpreter and transmit the resulting video to the videophone terminal of said deaf-mute person, a function to transmit at least a video from the videophone terminal of said deaf-mute person and an audio from the videophone terminal of said sign language interpreter to the videophone terminal for said non-deaf-mute person and a function to transmit at least a video from the videophone terminal of said deaf-mute person and an audio from the videophone terminal of said non-deaf-mute person to the videophone terminal of said sign language interpreter.

17. The sign language interpretation system according to the claim 16, wherein selection information for selecting a sign language interpreter is registered in said sign language interpreter registration table and said terminal connection means includes a function to acquire the conditions for selecting a sign language interpreter from said calling videophone terminal and a function to extract the terminal number of a sign language interpreter who satisfies said acquired selection conditions for the sign language interpreter from said sign language interpreter registration table.

18. The sign language interpretation system according to claim 16, wherein said sign language interpretation system includes a term registration table for registering a term used during sign language interpretation, wherein
said terminal connection means includes a function to register a term in said term registration table via an operation from a videophone terminal, a function to select a term to be used from the terms registered in said term registration table via an operation from a videophone terminal, a function to generate a telop of said selected term, and a function to synthesize said generated telop onto a video to be transmitted to a conversation partner.
